(19) United States
(12) Patent Application Publication
(10) Pub. No.: US 2026/0270391 A1
(43) Pub. Date: Sep. 10, 2026

(54) METHOD FOR ENCODING, METHOD FOR DECODING, DECODER AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/659,045

(22) Filed: Apr. 27, 2026

Related U.S. Application Data
(63) Continuation of application No. PCT/CN2023/129334, filed on Nov. 2, 2023.

(51) Int. Cl. H04N 19/103; H04N 19/159

(52) U.S. Cl. CPC H04N 19/103; H04N 19/159

(57) ABSTRACT

A method for decoding includes: at least one reference position around a current block is determined, where the at least one reference position includes a first reference position, the first reference position corresponds to a first reference block, the first reference block is predicted based on a first prediction mode, and the first prediction mode does not belong to a target intra prediction mode, the target intra prediction mode at least includes an angular prediction mode; a second prediction mode is determined according to a sample value of the first reference block, where the second prediction mode belongs to the target intra prediction mode; the second prediction mode is added to a candidate set of intra prediction modes; and the current block is predicted according to the candidate set.

### CROSS-REFERENCE TO RELATED APPLICATION

This application is a continuation of International Application No. PCT/CN2023/129334 filed on Nov. 2, 2023, the disclosure of which is hereby incorporated by reference in its entirety.

### TECHNICAL FIELD

The present disclosure relates to the technical field of video encoding and decoding, and in particular to a method for encoding, a method for decoding, a decoder, and a storage medium.

### BACKGROUND

The current block may construct a candidate set of intra prediction modes based on one or more surrounding reference positions to predict the current block. If the reference block at a certain reference position around the current block does not correspond to the conventional intra prediction mode (such as the angular prediction mode), how to accurately determine the conventional intra prediction mode corresponding to the reference block so as to improve the prediction performance of the current block is a problem that needs to be solved.

### BRIEF DESCRIPTION OF THE DRAWINGS

FIG. 1 is a schematic structural diagram of a video encoder to which an embodiment of the present disclosure can be applied.

FIG. 2 is a schematic structural diagram of a video decoder to which an embodiment of the present disclosure can be applied.

FIG. 3A is a schematic diagram of an intra prediction manner based on a decoder-side intra mode derivation (DIMD) mode.

FIG. 3B is a schematic diagram of a gradient histogram for a current block.

FIG. 4 is a schematic diagram of a manner of determining gradient information of a current block.

FIG. 5 is a schematic diagram of angular partition manners in a geometric partition mode (GPM) mode.

FIG. 6 is a schematic diagram of a reference template in a template-based intra mode derivation (TIMD) mode.

FIG. 7 is a schematic diagram of reference positions for constructing a candidate set.

FIG. 8 is another schematic diagram of reference positions for constructing a candidate set.

FIG. 9 is a schematic flowchart of a method for decoding according to an embodiment of the present disclosure.

FIG. 10 is a schematic flowchart of a method for encoding according to an embodiment of the present disclosure.

FIG. 11 is a schematic structural diagram of a decoder according to an embodiment of the present disclosure.

FIG. 12 is a schematic structural diagram of a decoder according to another embodiment of the present disclosure.

FIG. 13 is a schematic structural diagram of an encoder according to an embodiment of the present disclosure.

FIG. 14 is a schematic structural diagram of an encoder according to another embodiment of the present disclosure.

### DETAILED DESCRIPTION

Technical solutions in the present disclosure will be described below with reference to the drawings.

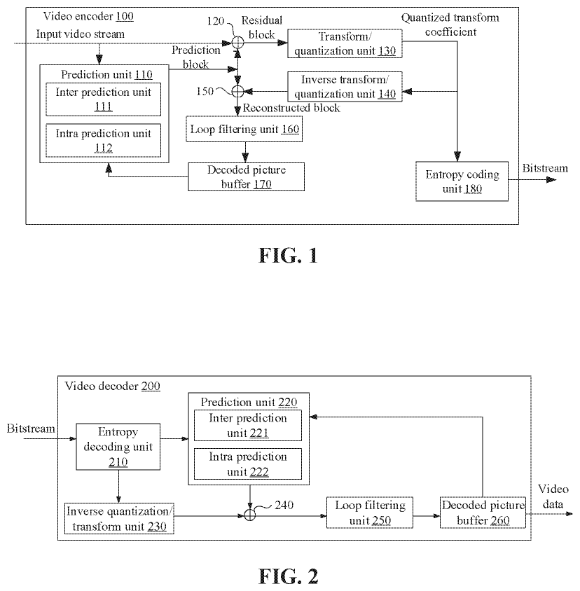

FIG. 1 is a schematic block diagram of a video encoder according to an embodiment of the present disclosure.

It is to be understood that the video encoder 100 may be configured to perform lossy compression on a picture, and also be configured to perform lossless compression on a picture. The lossless compression may be visually lossless compression or mathematically lossless compression.

The video encoder 100 may be applied to picture data in a luma-chroma (YCbCr, YUV) format. For example, the YUV may have a ratio of 4:2:0, 4:2:2, or 4:4:4, Y represents Luma, Cb (U) represents chroma of blue, Cr (V) represents chroma of red. U and V represent Chroma for describing colour and saturation. For example, for the colour format, 4:2:0 represents 4 luma components and 2 chroma components per 4 samples (YYYYCbCr), 4:2:2 represents 4 luma components and 4 chroma components per 4 samples (YYYYCbCrCbCr), and 4:4:4 represents full sample display (YYYYCbCrCbCrCbCrCbCr).

For example, the video encoder 100 reads the video data and for each picture in the video data, the picture is partitioned into multiple Coding Tree Units (CTUs). In some examples, the CTU may be referred to as a “tree block”, a “Largest Coding Unit” (LCU), or a “Coding Tree Block” (CTB). Each CTU may be associated with a sample block with an equal size in the picture. Each sample may correspond to one luminance (or, luma) sample and two chrominance (or, chroma) samples. Thus, each CTU may be associated with one luma sample block and two chroma sample blocks. One CTU may have a size of, such as, 128×128, 64×64, 32×32, etc. Furthermore, one CTU may be partitioned into several coding units (CUs) for coding, and the CUs may be rectangular blocks or square blocks. The CU may be further partitioned into prediction Units (PUs) and transform units (TUs), thereby separating the processing of encoding, prediction, and transform, and making the processing more flexible. In an example, the CTU is partitioned into CUs in a quadtree manner, and one CU is partitioned into TUs and PUs in a quadtree manner.

The video encoder and the video decoder may support various PU sizes. It is assumed that a specific CU has a size of 2N×2N, the video encoder and video decoder may support PUs having sizes of 2N×2N or N×N for intra prediction, and support symmetric PUs having sizes of 2N×2N, 2N×N, N×2N, N×N, or symmetric PUs having similar sizes for inter prediction. The video encoder and video decoder may also support asymmetric PUs having sizes of 2N×nU, 2N×nD, nL×2N, and nR×2N for inter prediction.

In some embodiments, as shown in FIG. 1, the video encoder 100 may include a prediction unit 110, a residual unit 120, a transform/quantization unit 130, an inverse transform/quantization unit 140, a reconstruction unit 150, a loop filtering unit 160, a decoded picture buffer 170, and an entropy coding unit 180. It should be noted that the video encoder 100 may include more, less or different functional components.

Optionally, in the present disclosure, the current block may be referred to as a current Coding Unit (CU), a current Prediction Unit (PU), or the like. A prediction block may also be referred to as a prediction picture block or a picture prediction block. A reconstructed picture block may also be referred to as a reconstructed block or a picture reconstructed block.

In some embodiments, the prediction unit 110 includes an inter prediction unit 111 and an intra prediction unit 112. Because there is a strong correlation between neighbouring samples one picture of the video, the spatial redundancy between the neighbouring samples can be eliminated by using the intra prediction method in video encoding and decoding technologies. Due to the strong similarity between neighbouring pictures in the video, the temporal redundancy between the neighbouring pictures is eliminated by using the inter prediction method in video encoding and decoding technologies, so that the coding efficiency can be improved.

The inter prediction unit 111 may be used for inter prediction, which may include motion estimation and motion compensation, may refer to picture information of different pictures. Inter prediction uses the motion information to find a reference block from the reference picture, and generates a prediction block according to the reference block for eliminating temporal redundancy. Inter prediction uses motion information to find a reference block from a reference picture, and generates a prediction block according to the reference block. The motion information includes a reference picture list where the reference picture is located, a reference picture index, and a motion vector. The motion vector may have integer-sample precision or fractional-sample precision. If the motion vector has fractional-sample precision, interpolation filtering is required to be performed on the reference picture to generate a required fractional-sample block. Here, the integer-sample block or the fractional-sample block found in the reference picture according to the motion vector is referred to the reference block. In some technologies, the reference block may be directly used as the prediction block, and in some technologies, the reference block may be reprocessed to generate the prediction block. The reference block being reprocessed to generate the prediction block may also be understood as taking the reference block as a prediction block and then processing the prediction block to generate a new prediction block.

The intra prediction unit 112 predicts sample information in the current picture block by referring only to the information of a same picture for eliminating spatial redundancy.

The intra prediction includes multiple prediction modes. Taking the H series of the international digital video coding standard as an example, in the H.264/AVC standard, there are 8 angular prediction modes and 1 non-angular prediction mode, and in the H.265/HEVC, the prediction mode is extended to include 33 angular prediction modes and 2 non-angular prediction modes. The intra prediction modes used in high efficiency video coding (HEVC) include 35 prediction modes including the planar mode, the direct current (DC) mode and 33 angular modes. The intra modes used in versatile video coding (VVC) include 67 prediction modes including the planar mode, the DC mode, and 65 angular modes.

It is to be noted that with the increase of the number of the angular modes, the intra prediction will be more accurate and more in line with the development requirements for the high-definition digital video and ultra-high-definition digital video.

The residual unit 120 may generate a residual block of the CU based on a sample block of the CU and a prediction block of the PU of the CU. For example, the residual unit 120 may generate a residual block of the CU, such that each sample in the residual block has a value equal to a difference between a sample in the sample block of the CU and a corresponding sample in the prediction block of the PU of the CU.

The transform/quantization unit 130 may quantize a transform coefficient. The transform/quantization unit 130 may quantize a transform coefficient associated with the TU of the CU based on a quantization parameter (QP) value associated with the CU. The video encoder 100 may adjust, by adjusting the QP value associated with the CU, the degree of quantization applied to the transform coefficient associated with the CU.

The inverse transform/quantization unit 140 may apply inverse quantization and inverse transform to the quantized transform coefficient, respectively, to reconstruct a residual block from the quantized transform coefficient.

The reconstruction unit 150 may add samples of the reconstructed residual block to corresponding samples of one or more prediction blocks generated by the prediction unit 110, to generate a reconstructed picture block associated with the TU. By reconstructing the sample blocks of each TU of the CU in this manner, the video encoder 100 may reconstruct the sample blocks of the CU.

The loop filtering unit 160 is configured to process the samples that are inversely-transformed and inversely-quantized to compensate for the distortion information and provide a better reference for subsequently encoding samples. For example, a deblocking filtering operation may be performed to reduce blocking artifacts of the sample block associated with the CU.

In some embodiments, the loop filtering unit 160 includes a deblocking filtering unit and a sample adaptive compensation/adaptive loop filter (SAO/ALF) unit. The deblocking filtering unit is configured to remove blocking artifacts and the SAO/ALF unit is configured to remove ringing artifacts.

The decoded picture buffer 170 may store the reconstructed sample block. The inter prediction unit 111 may perform the inter prediction on PUs of other pictures by using a reference picture including the reconstructed sample block. In addition, the intra prediction unit 112 may use the reconstructed sample block in the decoded picture buffer 170 to perform intra prediction on other PUs in the same picture as the CU.

The entropy coding unit 180 may receive the quantized transform coefficient from the transform/quantization unit 130. The entropy coding unit 180 may perform one or more entropy coding operations on the quantized transform coefficient to generate entropy-coded data.

FIG. 2 is a schematic block diagram of a video decoder according to an embodiment of the present disclosure.

As shown in FIG. 2, the video decoder 200 includes an entropy decoding unit 210, a prediction unit 220, an inverse quantization/transform unit 230, a reconstruction unit 240, a loop filtering unit 250, and a decoded picture buffer 260. It should be noted that the video decoder 200 may include more, less or different functional components.

The video decoder 200 may receive a bitstream. The entropy decoding unit 210 may parse the bitstream to extract syntax elements from the bitstream. As a part of parsing the bitstream, the entropy decoding unit 210 may parse the entropy-coded syntax elements in the bitstream. The prediction unit 220, the inverse quantization/transform unit 230, the reconstruction unit 240, and the loop filtering unit 250 may decode the video data according to the syntax elements extracted from the bitstream, i.e., may generate decoded video data.

In some embodiments, the prediction unit 220 includes an intra prediction unit 222 and an inter prediction unit 221.

The intra prediction unit 222 may perform intra prediction to generate a prediction block of the PU. The intra prediction unit 222 may use an intra prediction mode to generate a prediction block of a PU based on sample blocks of spatial neighbouring PUs. The intra prediction unit 222 may also determine an intra prediction mode for the PU according to one or more syntax elements parsed from the bitstream.

The inter prediction unit 221 may construct a first reference picture list (referred to List 0) and a second reference picture list (referred to List 1) based on syntax elements parsed from the bitstream. In addition, if the inter prediction coding is performed on the PU, the entropy decoding unit 210 may parse the motion information of the PU. The inter prediction unit 221 may determine one or more reference blocks of the PU according to the motion information of the PU. The inter prediction unit 221 may generate a prediction block of the PU from one or more reference blocks of the PU.

The inverse quantization/transform unit 230 may perform the reverse quantization (i.e., de-quantization) on the transform coefficient associated with the TU. The inverse quantization/transform unit 230 may determine the degree of quantization by using the QP value associated with the CU of the TU.

After the transform coefficient is inversely quantized, the inverse quantization/transform unit 230 may apply one or more inverse transforms to the inversely-quantized transform coefficient in order to generate a residual block associated with the TU.

The reconstruction unit 240 uses the residual block associated with the TU of the CU and the prediction block of the PU of the CU to reconstruct the sample block of the CU. For example, the reconstruction unit 240 may add a sample of the residual block to a respective sample of the prediction block to reconstruct the sample blocks of the CU, to obtain a reconstructed picture block.

The loop filtering unit 250 may perform a deblocking filtering operation to reduce blocking artifacts of the sample block associated with the CU.

The video decoder 200 may store the reconstructed picture of the CU in the decoded picture buffer 260. The video decoder 200 may use the reconstructed picture in the decoded picture buffer 260 as a reference picture for subsequent prediction, or transmit the reconstructed picture to a display device for presentation.

The basic process of video encoding and decoding is as follows. At the encoding end, one picture is partitioned into blocks. For a current block, the prediction unit 110 generates a prediction block of the current block by using the intra prediction or the inter prediction. The residual unit 120 may calculate a residual block based on the prediction block and the original block of the current block, i.e., calculating a difference between the prediction block and the original block of the current block, and the residual block may also be referred to as residual information. The residual block is transformed and quantized by the transform/quantization unit 130, and then information that is insensitive to the human eye may be removed to eliminate visual redundancy. Optionally, the residual block before being transformed and quantized by the transform/quantization unit 130 may be referred to as a time-domain residual block, and the time-domain residual block after being transformed and quantized by the transform/quantization unit 130 may be referred to as a frequency residual block or a frequency-domain residual block. The entropy coding unit 180 receives the quantized transform coefficient output from the transform/quantization unit 130, performs entropy coding on the quantized transform coefficient, and outputs a bitstream. For example, the entropy coding unit 180 may eliminate character redundancy according to the target context model and probability information of the binary bitstream.

At the decoding end, the entropy decoding unit 210 may parse the bitstream to obtain prediction information, quantization coefficient matrix, and the like of the current block, and the prediction unit 220 uses the intra prediction or the inter prediction to generate a prediction block of the current block based on the prediction information. The inverse quantization/transform unit 230 performs inverse quantization and inverse transform on the quantization coefficient matrix obtained from the bitstream to obtain residual blocks. The reconstruction unit 240 adds the prediction blocks to the residual blocks to obtain reconstructed blocks. The reconstructed blocks constitute a reconstructed picture, and the loop filtering unit 250 performs loop filtering on the reconstructed picture based on the picture or the blocks to obtain a decoded picture. The encoding end also needs similar operations as the decoding end to obtain the decoded picture. The decoded picture may also be referred to as a reconstructed picture, and the reconstructed picture may be used as a reference picture for performing the inter prediction on a subsequent picture.

It is to be note that the block partition information, and mode information or parameter information such as prediction, transform, quantization, entropy coding, loop filtering, or the like determined at the encoding end are carried in the bitstream when necessary. The decoding end, by parsing the bitstream and analyzing existing information, determines the same block partition information, as well as mode information or parameter information such as prediction information, transform information, quantization information, entropy coding information, in-loop filtering information, etc. as those at the encoding end, so as to ensure that the decoded picture obtained by the encoding end is the same as the decoded picture obtained by the decoding end.

The above is the basic flow of the video encoder and decoder under the block-based hybrid coding framework. With the development of the technology, some modules or operations of the framework or the flow may be optimized. The present disclosure is applicable to, but is not limited to, the basic flow of the video encoder and decoder under the block-based hybrid coding framework.

The encoding and decoding framework provided by the embodiments of the present disclosure has been described in detail above. The embodiments of the present disclosure mainly relate to an intra prediction process, which can be implemented by an intra prediction unit in the aforementioned encoding and decoding framework. Related concepts according to the embodiments of the present disclosure will be described in detail below.

### DIMD Mode

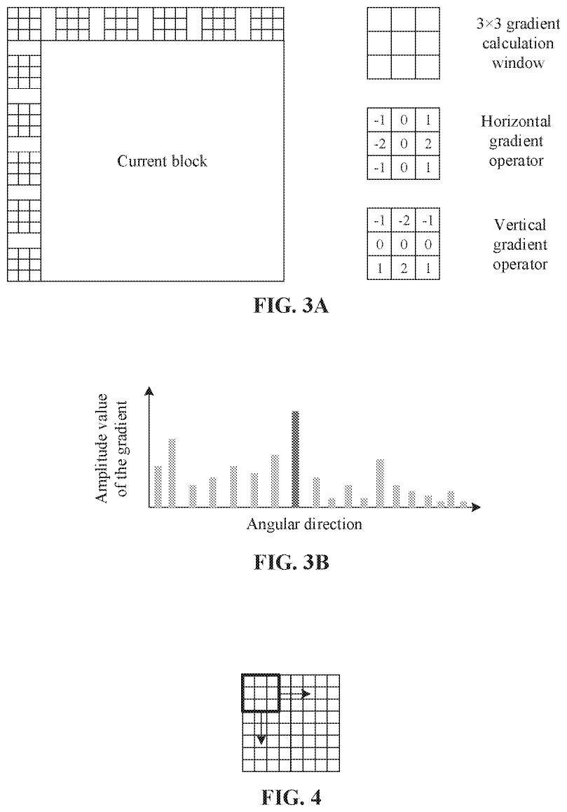

DIMD is an intra prediction tool. The DIMD technique can derive the intra prediction mode (or prediction direction) of the current block from the gradient information of the reconstructed region around the current block (the region where the reconstructed sample value is located). The DIMD technique may then obtain the prediction value according to the derived intra prediction mode. The gradient information may include horizontal gradient information and vertical gradient information, and each set of horizontal gradient information and vertical gradient information may correspond to a conventional prediction angle. An example of the matching method between gradient information and the conventional prediction angle will be provided below with reference to FIG. 3A and FIG. 3B.

As shown in FIG. 3A, a 3×3 sliding window may be used to slide over a reconstructed region of 3 rows and 3 columns around the current block in a step size of 1 sample to calculate the gradient values Gₓ and G_{y} in the horizontal and vertical directions for each 3×3 window on the reconstructed region. Gₓ and G_{y} can be obtained by performing a dot product between the Sobel operator and the prediction values within the window position, respectively. The Sobel operator is shown in formula (1), where Mₓ is used to calculate the horizontal gradient, and M_{y} is used to calculate the vertical gradient. The values of Mₓ and M_{y} are as follows.

$${M}_{x} = [ \begin{matrix}- 1 & 0 & 1 \\ - 2 & 0 & 2 \\ - 1 & 0 & 1\end{matrix} ] , {M}_{y} = [ \begin{matrix}- 1 & - 2 & - 1 \\ 0 & 0 & 0 \\ 1 & 2 & 1\end{matrix} ] \qquad ( 1 )$$

Then, the conventional angular direction O corresponding to each position can be calculated by the following formulas (2) and (3) according to Gₓ and G_{y} at each position, and the amplitude value G of the gradient of the angle corresponding to each position can be calculated.

$$G = \vert {G}_{x} \vert + \vert {G}_{y} \vert \qquad ( 2 )$$

$$0 = atan ( \frac{{G}_{y}}{{G}_{χ}} ) \qquad ( 3 )$$

In some implementations, the calculation process of the a tan may be simplified. For example, the calculation process of a tan can be simplified by looking up a table or employing formula variations.

Next, the magnitude values G of the gradients at each position can be separately accumulated over the conventional angle category from which they are derived to obtain a histogram of the magnitude values of the gradients (see FIG. 3B).

Finally, the conventional angle with the largest accumulated gradient amplitude value can be selected as the angle corresponding to the prediction block based on DIMD mode. When all the conventional angle-derived magnitude values are zero, the prediction block can be matched to the conventional planar mode.

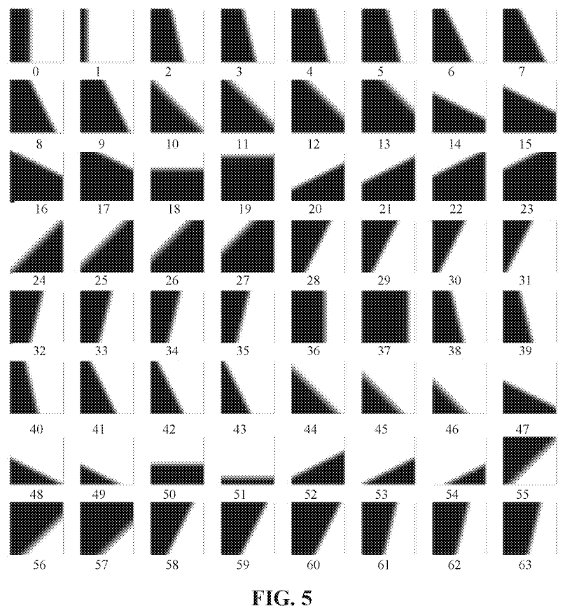

In addition to being used to determine the prediction mode, the DIMD may also be used for the selection of transform kernel set for the primary transform and the non-separable secondary transform. Specifically, different conventional angular prediction modes may correspond to different transform kernels. The transform kernels mentioned here may be multiple transform selection (MTS), non-separable primary transform (NSPT), low frequency non-separable secondary transform (LFNST), and the like. In the related art, the transform kernels may be partitioned into multiple sets, where each set may contain multiple transform kernels. When the prediction mode is the conventional transform mode, the selected conventional transform mode will determine the set of MTS, NSPT or LFNST, and the specific selected transform kernel will be determined by the identification parsed from the bitstream. If the prediction mode selected for the current block does not use the conventional prediction angle for prediction, it is impossible to determine the transform kernel set corresponding to the current block when predicting the current block, and thus the transform mode for the residual block of the current block cannot be determined. Therefore, in some implementations, the conventional prediction angle corresponding to the current block may be derived based on the DIMD mode. Then, the transform kernel set corresponding to the current block may be determined based on the prediction angle. With reference to FIG. 4, an example is provided below of determining a conventional prediction angle for the current block based on gradient information.

As shown in FIG. 4, a 3×3 sliding window may be used to slide in a current block in a step size of 1 sample to calculate the gradient values Gₓ and G_{y} in the horizontal and vertical directions for each 3×3 window in this current block. Gₓ and G_{y} can be obtained by performing a dot product between the 3×3 horizontal gradient operator Mₓ and the prediction values within the window position, and between the vertical gradient operator M_{y} and the prediction values within the window position, respectively. The values of Mₓ and M_{y} are shown in formula (1) above.

Assuming that the current block is a block with a width and height of (w, h), sliding the 3×3 window can calculate Gₓ and G_{y} for (w−2)×(h−2) positions at the center of the current block.

Then, the conventional angular direction θ corresponding to each position can be calculated by the above formulas (2) and (3) according to Gₓ and G_{y} at each position, and the amplitude value G of the gradient of the angle corresponding to each position can be calculated.

Next, the magnitude values G of the gradients at each position can be separately accumulated over the conventional angle category from which they are derived to obtain a histogram of the magnitude values of the gradients (see FIG. 3B).

Finally, the conventional angle with the largest accumulated gradient amplitude value can be selected as the conventional prediction angle corresponding to the current block. When all conventional angle-derived magnitude values are zero, the current block may be matched to the conventional planar mode.

The above-described DIMD method may also have some variations in actual implementation, and the embodiments of the present disclosure are not particularly limited thereto. For example, the operator used to calculate the horizontal gradient and the vertical gradient at each position may be different from Mₓ and M_{y} in the embodiments of the present disclosure. For another example, integer and shift or table lookup methods can also be used to simplify floating-point and division operations when calculating a tan. For another example, when an angle is corresponded to an existing angular mode, the correspondence may be performed using a table lookup method.

### Most Probable Mode (MPM) List

Neighbouring blocks in the same frame usually have strong correlation, so there is a high probability that the intra prediction modes of neighbouring blocks are the same or similar. The MPM constructs the MPM list of the current block through the intra prediction mode of the neighbouring block to predict the current block. For example, in HEVC, the length of the MPM list is 3, and in VVC, the length of the MPM list is 6.

Taking the reference software VVC test model (VTM) in VVC as an example, 6 MPMs can be generated through the prediction modes of two neighbouring blocks, and the modes in the MPM list can include the following three categories.
(1) Default mode.
(2) Neighbouring block mode.
(3) Calculated and derived mode.

### Spatial Geometric Partition Mode (SGPM) and GPM

Both the SGPM mode and the GPM mode are intra partition prediction modes. The SGPM mode is derived from the GPM mode. The current block can be partitioned into two parts based on the partition prediction mode, and different intra prediction modes can be used for prediction respectively.

Referring to FIG. 5, in the reference software ECM, the GPM supports 64 partition modes. Compared to GPM, SGPM supports 26 partition modes with different directions or positions among the total 64 modes. The 64 partition modes supported by GPM contain a total of 32 partition angles, among which the correspondence between these 32 partition angles and the conventional prediction angles is shown in Table 1. In Table 1, angleIdx represents 32 partition angles, and intraMode represents the index of the conventional 67 intra prediction modes (including the planar mode, the DC mode, and 65 angular prediction modes).

TABLE 1

| angle Idx | 0 | 1 | 2 | 3 | 4 | 5 | 6 | 7 |
|---|---|---|---|---|---|---|---|---|
| intra Mode | 50 | 0 | 44 | 41 | 34 | 27 | 0 | 0 |
| angle Idx | 8 | 9 | 10 | 11 | 12 | 13 | 14 | 15 |
| intra Mode | 18 | 0 | 0 | 9 | 66 | 59 | 56 | 0 |
| angle Idx | 16 | 17 | 18 | 19 | 20 | 21 | 22 | 23 |
| intra Mode | 50 | 0 | 44 | 41 | 34 | 27 | 0 | 0 |
| angle Idx | 24 | 25 | 26 | 27 | 28 | 29 | 30 | 31 |
| intra Mode | 18 | 0 | 0 | 9 | 66 | 59 | 56 | 0 |

### TIMD Mode

Intra prediction technology based on TIMD mode can derive information of intra prediction mode according to several rows of sample values reconstructed around the current block, and then derive one or more conventional intra prediction modes.

In the reference software ECM-7.0, four intra prediction modes can be derived from the TIMD mode, namely, the TIMD mode, the TIMD secondary mode, the TIMD horizontal mode (TIMD hor), and the TIMD vertical mode (TIMD ver).

The TIMD mode can further partition 65 conventional prediction angles into 129 prediction angles. That is, a finer angle can be added between every two neighbouring conventional prediction angles.

The TIMD mode derives the intra prediction mode based on the magnitude of the cost value at the template position. For example, the sum of absolute transformed differences (SATD) may be used in the reference software ECM as the magnitude of the cost value of the template position. Referring to FIG. 6, a row L2 above the current block can be used as a top template, a row L1 on the left can be used as a left template, and a row of reconstructed sample values (reference of the template) outside the template region is used as a reference sample. Predictions are made on the template region in a given intra prediction mode. The prediction process may be to generate a prediction value for the template region using each conventional prediction mode in the MPM list based on the reference sample value. Then, the SATD of the prediction value and reconstructed value of the template region is calculated. The conventional prediction mode with the smallest SATD is selected as the TIMD mode and used for the prediction of the current block.

In the template region, the SATD value between the prediction value and the reconstructed value obtained based on the prediction mode is the magnitude of the cost value. The TIMD mode can distinguish the above four TIMD prediction modes according to the SATD value, and the specific way is as follows.
(1) The TIMD mode is a mode with the smallest total SATD value on both the top template and left template.
(2) The TIMD secondary mode is a mode with the second smallest total SATD value on both the top template and left template.
(3) The TIMD vertical mode (TIMD ver) is a mode with the smallest SATD value on the top template.
(4) The TIMD horizontal mode (TIMD hor) is a mode with the smallest SATD value on the left template.

In the reference software ECM, the TIMD mode and the TIMD secondary mode can perform adaptive weighted prediction. Specifically, the prediction value of the TIMD mode in the current block is weighted with the prediction value of the TIMD secondary mode in the current block. Whether weighting is performed and the weights for the weighting are related to the SATD values of the two modes.

In some implementations, whether adaptive weighted prediction is performed for the TIMD mode and the TIMD secondary mode can be determined as follows.
(1) The TID mode is the mode with the smallest SATD value, and its SATD value may be cost0, and the TIMD secondary mode is the mode with the second smallest SATD value, and its SATD value may be cost1.
(2) When cost0*2>cost1, the prediction values of the above two prediction modes for the current block will be weighted, otherwise the prediction values of the TIMD mode will be directly used.
(3) During weighting, the ratio of the weights is as shown in formulas (4) and (5), where Pred_{timdMode} is the prediction result of the TIMD mode for the current block, and Pred_{timdSecondaryMode} is the prediction value of the TIMD secondary mode for the current block.

$$w 0 = \frac{cost 1}{cost 0 + cost 1} , w 1 = \frac{cost 0}{cost 0 + cost 1} \qquad ( 4 )$$

$$Pred = {Pred}_{timdMode} \times w 0 + {Pred}_{timdSecondaryMode} \times w 1 \qquad ( 5 )$$

In some implementations, in order to avoid the floating-point calculation and the division calculation, the value of w0+w1 is scaled to 64, and the division calculation of w0 and w1 is also performed using a lookup table, and the final weighting process is shown in formula (6).

$$Pred = ( {Pred}_{timdMode} \times w 0 + {Pred}_{timdSecondaryMode} \times w1 ) ≫ 6 \qquad ( 6 )$$

The prediction mode derived from the TIMID mode originates from the candidate list of intra prediction modes.

### Template-Based Multiple Reference Line Intra Prediction (TMRL) Mode

The reference software ECM-7.0 includes the TMRL mode. The TMRL mode is an intra prediction mode. TMRL technique is a template matching-based MRL technique. The process of predicting the current block based on the TMRL mode is as follows.
(1) In the stage of parsing the bitstream: the bitstream is parsed to confirm that the current block uses the TMRL mode, and the list index of the TMRL is parsed.
(2) In the prediction and reconstruction stage of the current block: a candidate list of the TMRL mode is first constructed. The syntax elements in the selected TMRL list are determined according to the candidate list of the TMRL mode and the decoded list index. Each syntax element consists of an intra prediction mode and a reference line index. A process such as predicting and reconstructing the current block using the confirmed intra prediction mode and the corresponding reference line.

The construction of the TMRL list is an operation that both the encoder and decoder need to perform. The TMRL mode may select the index of the reference line in the candidate list by encoding and decoding. The actual selected reference line is determined in the sorted candidate list based on the index. Then, prediction is performed using the reference line and the selected intra prediction mode (conventional prediction mode).

The TMRL mode uses the sum of absolute differences (SAD) between the prediction values and reconstructed values on the template region for up to 5 predefined extended reference lines (e.g., the extended reference lines can be 1, 3, 5, 7, and 12 lines. The specific extended reference lines used depend on the position of the current block in the current CTU. Certainly, less than 5 extended reference lines can also be used). The 5 extended reference lines and 10 predefined prediction modes may form up to 5×10 combinations for sorting.

$$SAD = {\sum }_{x = 0}^{w - 1} \vert {pred}_{( x , - 1 )} - {reco}_{( x , - 1 )} \vert + {\sum }_{y = 0}^{h - 1} \vert {pred}_{( - 1 , y )} - {reco}_{( - 1 , y )} \vert \qquad ( 7 )$$

(x, −1), (−1, y) are the coordinates of the position relative to the top-left corner (0, 0) of the current block, respectively, and the template for calculating the SAD is a region of 1 row and 1 column.

From the above introduction, it can be seen that if the above mode is used to predict the current block, a candidate set (or a candidate list) constructed by the conventional intra prediction modes needs to be established. In the related art, a candidate set may be constructed by acquiring conventional intra prediction modes of blocks at neighbouring and non-neighbouring positions, and adding the conventional intra prediction modes to the candidate set without repetition. In some implementations, when the acquired conventional intra prediction modes cannot fill the to-be-constructed candidate set to the required size, further expansion is performed based on the already added conventional intra prediction modes. For example, if one angular prediction mode is included in the candidate set, other angular prediction modes that are similar to the angular prediction mode may be added to the candidate set. For example, if the angular prediction mode 50 is added to the candidate set, the angular prediction mode 49, the angular prediction mode 51, and the like may be added to the candidate set.

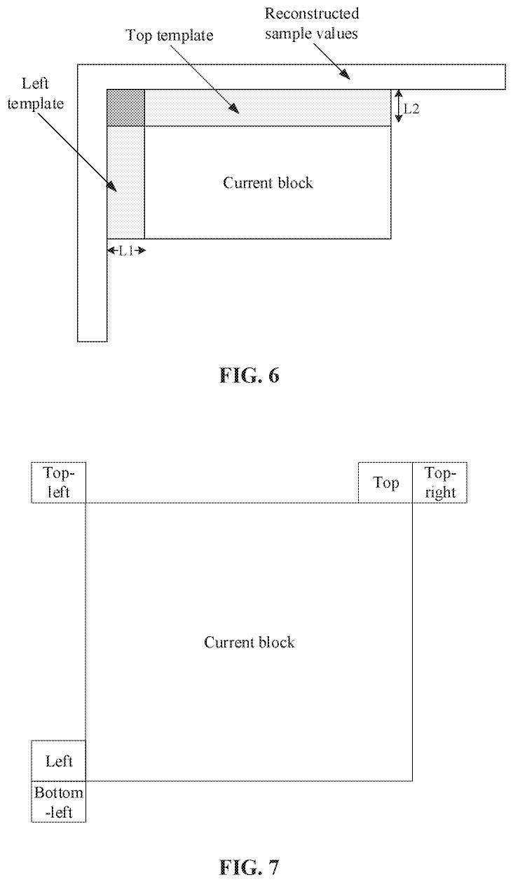

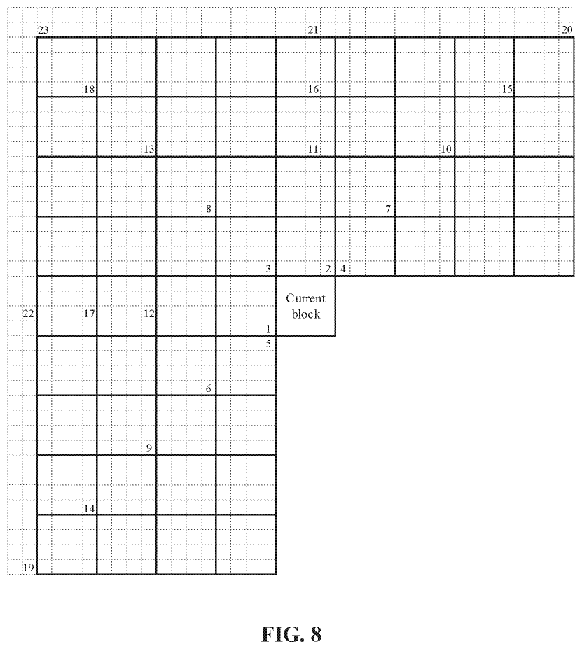

As an example, in SGPM and GPM, the candidate set described above is constructed, as shown in FIG. 7, reference blocks at 5 neighbouring positions, namely, left, top-left, bottom-left, and top-right regions, need to be referred to.

As another example, in MPM, TIMD, and TMRL, as shown in FIG. 8, reference blocks of 18 non-neighbouring positions need to be considered in addition to reference blocks of 5 neighbouring positions.

Certainly, in addition to the prediction mode described above, there are other modes that also need to construct a candidate set for intra prediction, which will not be described in detail here.

Based on the above introduction, the current block may construct a candidate set of intra prediction modes based on one or more surrounding reference positions to predict the current block. When constructing the candidate set, it is necessary to acquire the conventional intra prediction modes of reference blocks at reference positions and add these conventional intra prediction modes to the candidate set. Reference blocks predicted based on different prediction modes acquire conventional intra prediction modes in different manners. The reference block may be predicted, for example, based on an intra prediction mode, an intra block coding mode, and an inter prediction mode. A manner of acquiring a conventional intra prediction mode of a reference block in the related art will be described below in two cases.

In the first case, the reference block at the reference position corresponds to a conventional intra prediction mode. For example, if the current block uses MIP, the planar mode in the conventional intra mode of the reference block may be acquired. For another example, if the current block uses SGPM, the conventional intra prediction angle corresponding to the reference block partition angle may be acquired. For another example, if the current block uses TIMD or DIMD, the conventional intra prediction mode with the highest weight for the weighting derived by the reference block may be acquired. For another example, if the current block uses GPM, the conventional intra prediction angle corresponding to the reference block partition angle may be acquired.

In the second case, the reference block at the reference position does not correspond to a conventional intra prediction mode. For example, if the reference block is predicted based on an intra block coding mode or an inter prediction mode, there may be no corresponding conventional intra prediction mode. In the related art, in order to construct a candidate set, if a reference block does not correspond to a conventional intra prediction mode, a reference block of the reference block may be found by motion information of the reference block, and the conventional intra prediction mode of the reference block of the reference block may be added to the candidate set. There are various ways to find a reference block of the reference block based on the motion information. For example, if the reference block is predicted based on the inter prediction mode, the reference block of the reference block can be found by a motion vector obtained in the inter prediction mode, and for example, if the reference block is predicted based on the intra block coding mode, the reference block of the reference block can be found by a block vector obtained in the intra block coding mode.

As can be seen from the above introduction, if the reference block at a certain reference position around the current block does not correspond to the conventional intra prediction mode (such as the angular prediction mode), how to accurately determine the conventional intra prediction mode corresponding to the reference block so as to improve the prediction performance of the current block is a problem that needs to be solved.

In view of the above problems, in the embodiment of the present disclosure, if the reference block at the reference position around the current block does not correspond to the conventional intra prediction mode or the conventional intra prediction mode is not used for prediction, the corresponding conventional intra prediction mode can be determined based on the sample value of the reference block itself. The intra prediction mode determined based on the sample value of the reference block itself is more accurate, which helps to improve the prediction performance of the current block.

A method for decoding according to an embodiment of the present disclosure will be described in detail below with reference to FIG. 9.

FIG. 9 is a schematic flowchart of a method for decoding according to an embodiment of the present disclosure. The method of FIG. 9 may also be referred to as an intra prediction method. The method of FIG. 9 can be applied to a decoder.

Referring to FIG. 9, in operation S910, at least one reference position around the current block is determined.

The current block may refer to a to-be-predicted current block or a to-be-decoded current block. In some implementations, the current block is a luma block. In other implementations, the current block may also be a chroma block.

The reference positions around the current block may include, for example, the reference positions shown in FIG. 7. Alternatively, the reference positions around the current block may include the reference positions shown in FIG. 8.

The at least one reference position mentioned above may include a first reference position. The first reference position corresponds to a first reference block (or the first reference block includes the first reference position). The first reference block is predicted based on the first prediction mode. The first prediction mode mentioned here does not belong to the target prediction mode.

The target intra prediction mode mentioned in the embodiment of the present disclosure may refer to a conventional intra prediction mode. For example, the target intra prediction mode may include at least a conventional angular prediction mode. In some implementations, the target intra prediction mode may further include one or more of a planar mode or a DC mode. Therefore, “the first reference block is predicted based on the first prediction mode, and the first prediction mode does not belong to the target prediction mode” may also be understood as the first prediction mode corresponding to the first reference block is not the conventional intra prediction mode.

In operation S920, a second prediction mode is determined based on a sample value of the first reference block. The second prediction mode belongs to the target intra prediction mode, or the second prediction mode belongs to the conventional intra prediction mode.

The sample value of the first reference block mentioned above may be the sample value of the prediction block, or the sample value of the first reference block may also be the sample value of the reconstructed block.

In some implementations, the gradient information corresponding to at least one angle may be determined according to the sample value of the first reference block, and the second prediction mode is determined according to the gradient information corresponding to the at least one angle. The gradient information corresponding to the at least one angle may also be referred to as gradient information corresponding to at least one angular prediction mode. The gradient information mentioned herein may be, for example, a gradient histogram. Determining the second prediction mode according to the gradient information corresponding to the at least one angle mentioned above may include determining the second prediction mode according to the gradient amplitude value corresponding to the at least one angle. For example, the angular prediction mode corresponding to the gradient with the largest amplitude value may be used as the second prediction mode.

There may be multiple ways to determine the gradient information.

For example, the gradient information may be determined based on the DIMD mode. Exemplarily, taking the first reference block as the block in FIG. 4 as an example, a 3×3 sliding window may be used to slide within the first reference block to calculate gradient information for each 3×3 window on the first reference block.

For another example, the gradient information may be determined based on some variant mode of the DIMD mode. Exemplarily, operators other than the Sobel operator may also be used when acquiring gradient information. For example, operations such as shifting, multiplication, or table lookup may be used instead of calculating a tan or triggering operations when calculating an angle. For example, a lookup table or the like may also be used when calculating a conventional intra prediction mode angle corresponding to an angle. The gradient information may include, for example, an amplitude value of the gradient. The above statement “the second prediction mode is determined according to the gradient information corresponding to the at least one angle” can also be understood as determining the second prediction mode based on the magnitude value corresponding to the at least one angle. For example, an angle value corresponding to the maximum magnitude value is found in the gradient histogram of the first reference block, and the angular prediction mode corresponding to the angle value may be used as the second prediction mode.

With continued reference to FIG. 9, in operation S930, the second prediction mode is added to the candidate set of intra prediction modes. The embodiment of the present disclosure does not specifically limit the candidate set, and the candidate set may be constructed based on any prediction mode.

In operation S940, the current block is predicted according to the candidate set.

In the related art, if the prediction mode corresponding to the current block (that is, the first prediction mode mentioned above) is a prediction mode based on motion information, a reference block of the first reference block is determined based on the motion information, and then the intra prediction mode corresponding to the reference block of the first reference block is added to the intra prediction mode candidate set. However, the reference block of the first reference block is far away from the position of the current block, and constructing an intra prediction mode candidate set based on its corresponding intra prediction mode will degrade the prediction performance.

Therefore, in some implementations, if the first reference block is predicted based on motion information, the second prediction mode may be determined according to the sample value of the first reference block in the manner described in operation S920. That is, if the first reference block is predicted based on motion information, the corresponding intra prediction mode can be directly determined based on the sample value of the first reference block itself, and the intra prediction mode determined based on the sample value of the reference block itself is more accurate, which helps to improve the prediction performance of the current block.

It should be understood that the operation information mentioned above may be, for example, a motion vector used in inter prediction or a block vector used in intra prediction. For example, the first prediction mode may include an intra block coding mode. The intra block coding mode may also be referred to as an intra block copy (IBC) mode. As another example, the first prediction mode may include the inter prediction mode.

In some implementations, the first prediction mode mentioned above may include GPM. That is, if the first reference block is predicted based on GPM, the corresponding intra prediction mode can be directly determined based on the sample value of the first reference block itself according to operation S920, and the intra prediction mode determined based on the sample value of the reference block itself is more accurate, which helps to improve the prediction performance of the current block.

In some implementations, the first prediction mode mentioned above may not include GPM. This is because if the prediction mode corresponding to the current block is GPM, the conventional prediction mode corresponding to the first reference block may be determined based on the correspondence between the GPM and the conventional intra prediction mode, and the conventional prediction mode may be added to the intra prediction mode candidate list of the current block. This implementation does not need to determine the conventional prediction mode corresponding to the current block according to the sample value of the current block, so that the complexity of the encoding end can be reduced.

If the amplitude values corresponding to each angle in the gradient histogram of the first reference block are comparatively average, adding the second prediction mode determined according to the gradient information to the intra prediction mode candidate set may reduce the effectiveness of the intra prediction mode in the candidate set.

Thus, in some implementations, in a case that the amplitude value corresponding to the at least one angle meets a first preset condition, the second prediction mode is added to the candidate set of the intra prediction modes.

For example, the first preset condition may be associated with a maximum amplitude value among the amplitude values corresponding to the at least one angle. For example, the second prediction mode is added to the candidate set of intra prediction modes if the maximum magnitude value is greater than or equal to a target value. The target value is determined according to a sum of remaining magnitude values other than the maximum magnitude value among the magnitude values corresponding to at least one angle. By setting the first preset condition for the amplitude value corresponding to at least one angle, some second prediction modes with poor accuracy may not be added to the candidate set, which helps to further improve the accuracy of prediction of the candidate set.

Exemplarily, continuing with the gradient histogram of the first reference block as an example. In this histogram, it is assumed that the maximum amplitude value is set to Amp₀, and the sum of the amplitude values of all angles except the maximum amplitude value Amp₀ is set to Ampₛᵤₘ₋₁. The derived conventional prediction mode is used as the second prediction mode of the first reference block only when the relationship of the following formula (8) is met.

$${Amp}_{0} \times N \geq {Amp}_{sum - 1} \qquad ( 8 )$$

N is a positive integer greater than or equal to 1, for example, N is equal to 1, 2, 3, or the like.

For another example, the second prediction mode is added to the candidate set of intra prediction modes if the maximum magnitude value is greater than or equal to a target value. The target value is determined according to a sum of all of the magnitude values corresponding to at least one angle.

Exemplarily, continuing with the gradient histogram of the first reference block as an example. In this histogram, assume the maximum magnitude value is Amp₀, and the sum of magnitude values of all angles is Ampₛᵤₘ. The derived conventional prediction mode is used as the second prediction mode for the first reference block only when the relationship in the following formula (9) is met.

$${Amp}_{0} \times N \geq {Amp}_{sum} \qquad ( 9 )$$

N is a positive integer greater than or equal to 2, for example, N is equal to 2, 3, 4, or the like.

The embodiment of the present disclosure does not specifically limit the size of the first reference block. In some implementations, the first reference block may be a reference block of any size. Alternatively, in other implementations, the first reference block may be a reference block whose size meets a second preset condition. That is, in a case that a size of the first reference block meets a second preset condition, the second prediction mode is determined based on the sample value of the first reference block. For example, the second preset condition may be a relationship between the size of the first reference block and the first size. For example, if the size of the first reference block is greater than or equal to the first size, it is allowed to determine the second prediction mode according to the sample value of the first reference block. If the size of the first reference block is smaller than the first size, it is not allowed to determine the second prediction mode according to the sample value of the first reference block. For a reference block having a larger size, the second prediction mode determined based on its sample value may consume excessive time. Therefore, by setting the above second preset condition, such reference blocks can be excluded, thereby saving prediction time for the current block.

As mentioned above, the current block can be predicted according to the candidate set. In some implementations, the intra prediction mode of the current block may be determined according to the candidate set, and the prediction value of the current block may be determined according to the intra prediction mode of the current block. For example, the bitstream may be parsed to determine the first index information. The first index information is used to determine the intra prediction mode of the current block from the candidate set. Then, the intra prediction mode of the current block may be determined from the candidate set according to the first index information.

In some implementations, the method of FIG. 9 may further include parsing the bitstream to determine the first identification information. The first identification information indicates that the prediction mode of the current block is the target prediction mode. The target prediction mode is a mode in which prediction is performed based on a candidate set. For example, the target prediction mode may include one or more of MPM, TIMD, TMRL, SGPM, or GPM.

The first identification information may be represented by, for example, m_flag (m indicates a type of the prediction mode, for example, m may be MPM). Certainly, the first identification information may be represented by any other letter and/or number.

In some implementations, the method of FIG. 9 may further include: parsing the bitstream, determining quantized coefficient of the current block; inversely quantizing the quantized coefficient to determine the transform coefficient of the current block; and inversely transforming the transform coefficient to determine the residual information of the current block.

In some implementations, the method of FIG. 9 may further include determining reconstructed information of the current block according to the prediction value and residual information of the current block. For example, the prediction value and the residual value of the current block may be summed, and the summation result may be taken as the reconstructed value of the current block.

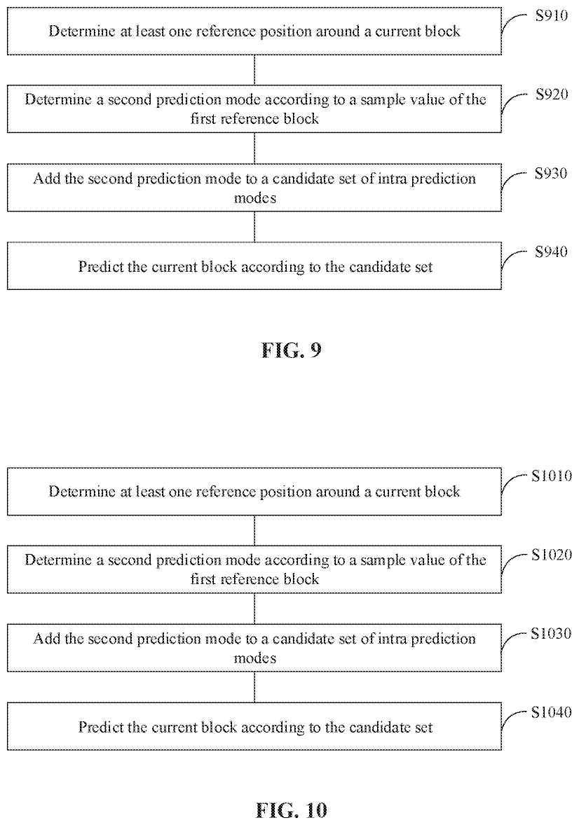

A method for decoding provided by an embodiment of the present disclosure has been described in detail above with reference to FIG. 9. A method for encoding provided by an embodiment of the present disclosure will be described in detail below with reference to FIG. 10.

FIG. 10 is a schematic flowchart of a method for encoding according to an embodiment of the present disclosure. The method of FIG. 10 may also be referred to as an intra prediction method. The method of FIG. 10 can be applied to an encoder.

Referring to FIG. 10, in operation S1010, at least one reference position around the current block is determined.

The current block may refer to a to-be-predicted current block or a to-be-encoded current block. In some implementations, the current block is a luma block. In other implementations, the current block may also be a chroma block.

The reference positions around the current block may include, for example, the reference positions shown in FIG. 7. Alternatively, the reference positions around the current block may include the reference positions shown in FIG. 8.

The at least one reference position mentioned above may include a first reference position. The first reference position corresponds to a first reference block (or the first reference block includes the first reference position). The first reference block is predicted based on the first prediction mode. The first prediction mode mentioned here does not belong to the target prediction mode.

The target intra prediction mode mentioned in the embodiment of the present disclosure may refer to a conventional intra prediction mode. For example, the target intra prediction mode may include at least a conventional angular prediction mode. In some implementations, the target intra prediction mode may further include one or more of a planar mode or a DC mode. Therefore, “the first reference block is predicted based on the first prediction mode, and the first prediction mode does not belong to the target prediction mode” may also be understood as the first prediction mode corresponding to the first reference block is not the conventional intra prediction mode.

In operation S1020, a second prediction mode is determined based on a sample value of the first reference block. The second prediction mode belongs to the target intra prediction mode, or the second prediction mode belongs to the conventional intra prediction mode.

The sample value of the first reference block mentioned above may be the sample value of the prediction block, or the sample value of the first reference block may also be the sample value of the reconstructed block.

In some implementations, the gradient information corresponding to at least one angle may be determined according to the sample value of the first reference block, and the second prediction mode is determined according to the gradient information corresponding to the at least one angle. The gradient information corresponding to the at least one angle may also be referred to as gradient information corresponding to at least one angular prediction mode. The gradient information mentioned herein may be, for example, a gradient histogram. Determining the second prediction mode according to the gradient information corresponding to the at least one angle mentioned above may include determining the second prediction mode according to the gradient amplitude value corresponding to the at least one angle. For example, the angular prediction mode corresponding to the gradient with the largest amplitude value may be used as the second prediction mode.

There may be multiple ways to determine the gradient information. For example, the gradient information may be determined based on the DIMD mode. Exemplarily, taking the first reference block as the block in FIG. 4 as an example, a 3×3 sliding window may be used to slide within the first reference block to calculate gradient information for each 3×3 window on the first reference block.

For another example, the gradient information may be determined based on some variant mode of the DIMD mode. Exemplarily, operators other than the Sobel operator may also be used when acquiring gradient information. For example, operations such as shifting, multiplication, or table lookup may be used instead of calculating a tan or triggering operations when calculating an angle. For example, a lookup table or the like may also be used when calculating a conventional intra prediction mode angle corresponding to an angle.

The gradient information may include, for example, an amplitude value of the gradient. The above statement “the second prediction mode is determined according to the gradient information corresponding to the at least one angle” can also be understood as determining the second prediction mode based on the magnitude value corresponding to the at least one angle. For example, an angle value corresponding to the maximum magnitude value is found in the gradient histogram of the first reference block, and the angular prediction mode corresponding to the angle value may be used as the second prediction mode.

With continued reference to FIG. 10, in operation S1030, the second prediction mode is added to the candidate set of intra prediction modes. The embodiment of the present disclosure does not specifically limit the candidate set, and the candidate set may be constructed based on any prediction mode.

In operation S1040, the current block is predicted according to the candidate set.

In the related art, if the prediction mode corresponding to the current block (that is, the first prediction mode mentioned above) is a prediction mode based on motion information, a reference block of the first reference block is determined based on the motion information, and then the intra prediction mode corresponding to the reference block of the first reference block is added to the intra prediction mode candidate set. However, the reference block of the first reference block is far away from the position of the current block, and constructing an intra prediction mode candidate set based on its corresponding intra prediction mode will degrade the prediction performance.

Therefore, in some implementations, if the first reference block is predicted based on motion information, the second prediction mode may be determined according to the sample value of the first reference block in the manner described in operation S1020. That is, if the first reference block is predicted based on motion information, the corresponding intra prediction mode can be directly determined based on the sample value of the first reference block itself, and the intra prediction mode determined based on the sample value of the reference block itself is more accurate, which helps to improve the prediction performance of the current block.

It should be understood that the operation information mentioned above may be, for example, a motion vector used in inter prediction or a block vector used in intra prediction. For example, the first prediction mode may include an intra block coding mode. The intra block coding mode may also be referred to as an intra block copy (IBC) mode. As another example, the first prediction mode may include the inter prediction mode.

In some implementations, the first prediction mode mentioned above may include GPM. That is, if the first reference block is predicted based on GPM, the corresponding intra prediction mode can be directly determined based on the sample value of the first reference block itself according to operation S1020, and the intra prediction mode determined based on the sample value of the reference block itself is more accurate, which helps to improve the prediction performance of the current block.

In some implementations, the first prediction mode mentioned above may not include GPM. This is because if the prediction mode corresponding to the current block is GPM, the conventional prediction mode corresponding to the first reference block may be determined based on the correspondence between the GPM and the conventional intra prediction mode, and the conventional prediction mode may be added to the intra prediction mode candidate list of the current block. This implementation does not need to determine the conventional prediction mode corresponding to the current block according to the sample value of the current block, so that the complexity of the encoding end can be reduced.

If the amplitude values corresponding to each angle in the gradient histogram of the first reference block are comparatively average, adding the second prediction mode determined according to the gradient information to the intra prediction mode candidate set may reduce the effectiveness of the intra prediction mode in the candidate set.

Thus, in some implementations, in a case that the amplitude value corresponding to the at least one angle meets a first preset condition, the second prediction mode is added to the candidate set of the intra prediction modes.

For example, the first preset condition may be associated with a maximum amplitude value among the amplitude values corresponding to the at least one angle. For example, the second prediction mode is added to the candidate set of intra prediction modes if the maximum magnitude value is greater than or equal to a target value. The target value is determined according to a sum of remaining magnitude values other than the maximum magnitude value among the magnitude values corresponding to at least one angle. By setting the first preset condition for the amplitude value corresponding to at least one angle above, some second prediction modes with poor accuracy may not be added to the candidate set, which helps to further improve the accuracy of prediction of the candidate set.

Exemplarily, continuing with the gradient histogram of the first reference block as an example. In this histogram, it is assumed that the maximum amplitude value is set to Amp₀, and the sum of the amplitude values of all angles except the maximum amplitude value Amp₀ is set to Ampₛᵤₘ₋₁. The derived conventional prediction mode is used as the second prediction mode of the first reference block only when the relationship of the following formula (8) is met.

$${Amp}_{0} \times N \geq {Amp}_{sum - 1} \qquad ( 8 )$$

N is a positive integer greater than or equal to 1, for example, N is equal to 1, 2, 3, or the like.

For another example, the second prediction mode is added to the candidate set of intra prediction modes if the maximum magnitude value is greater than or equal to a target value. The target value is determined according to a sum of all of the magnitude values corresponding to at least one angle.

Exemplarily, continuing with the gradient histogram of the first reference block as an example. In this histogram, assume the maximum magnitude value is Amp₀, and the sum of magnitude values of all angles is Ampₛᵤₘ. The derived conventional prediction mode is used as the second prediction mode for the first reference block only when the relationship in the following formula (9) is met.

$${Amp}_{0} \times N \geq {Amp}_{sum} \qquad ( 9 )$$

N is a positive integer greater than or equal to 2, for example, N is equal to 2, 3, 4, or the like.

The embodiment of the present disclosure does not specifically limit the size of the first reference block. In some implementations, the first reference block may be a reference block of any size. Alternatively, in other implementations, the first reference block may be a reference block whose size meets a second preset condition. That is, in a case that a size of the first reference block meets a second preset condition, the second prediction mode is determined based on the sample value of the first reference block. For example, the second preset condition may be a relationship between the size of the first reference block and the first size. For example, if the size of the first reference block is greater than or equal to the first size, it is allowed to determine the second prediction mode according to the sample value of the first reference block. If the size of the first reference block is smaller than the first size, it is not allowed to determine the second prediction mode according to the sample value of the first reference block. For a reference block having a larger size, the second prediction mode determined based on its sample value may consume excessive time. Therefore, by setting the above second preset condition, such reference blocks can be excluded, thereby saving prediction time for the current block.

As mentioned above, the current block can be predicted according to the candidate set. In some implementations, the intra prediction mode of the current block may be determined according to the candidate set, and the prediction value of the current block may be determined according to the intra prediction mode of the current block.

In some implementations, the method of FIG. 10 may further include signalling first identification information in a bitstream. The first identification information indicates that the prediction mode of the current block is the target prediction mode. The target prediction mode is a mode in which prediction is performed based on a candidate set. For example, the target prediction mode may include one or more of MPM, TIMD, TMRL, SGPM, or GPM.

The first identification information may be represented by, for example, m_flag (m indicates a type of the prediction mode, for example, m may be MPM). Certainly, the first identification information may be represented by any other letter and/or number.

In some implementations, the method of FIG. 10 may further include signalling first index information in a bitstream. The first index information is used to determine the intra prediction mode of the current block from the candidate set.

In some implementations, index information may include an index value based on which the intra prediction mode of the current block may be determined directly from the candidate set.

In some implementations, the method of FIG. 10 further includes: transforming residual information to determine transform coefficient; quantizing the transform coefficient to obtain the quantized coefficient; and encoding the quantized coefficient, and signalling the encoded bits in the bitstream.

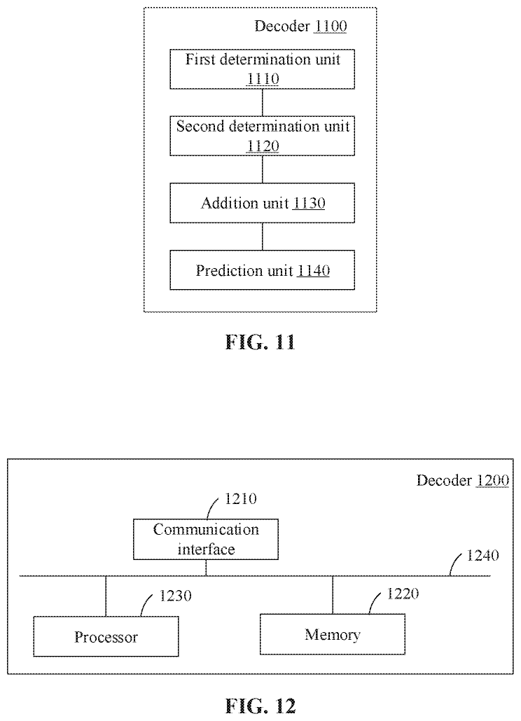

The method embodiments of the present disclosure are described in detail above with reference to FIGS. 1 to 10, and device embodiments of the present disclosure will be described in detail below with reference to FIGS. 11 to 14. It should be understood that the description of the method embodiments and the description of the device embodiments correspond to each other, and therefore, the portions not described in detail can be referred to the foregoing method embodiments.

FIG. 11 is a schematic structural diagram of a decoder according to an embodiment of the present disclosure. As shown in FIG. 11, the decoder 1100 includes a first determination unit 1120, a second determination unit 1130, an addition unit 1130, and a prediction unit 1140.

The first determination unit 1100 is configured to determine at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode.

The second determination unit 1120 is configured to determine a second prediction mode according to a sample value of the first reference block, the second prediction mode belonging to the target intra prediction mode.

The addition unit 1130 is configured to add the second prediction mode to a candidate set of intra prediction modes.

The prediction unit 1140 is configured to predict the current block according to the candidate set.

In some implementations, the first prediction mode is a prediction mode based on motion information.

In some implementations, the first prediction mode includes at least one of an intra block coding mode or an inter prediction mode.

In some implementations, the first prediction mode includes only an intra block coding mode; or, the first prediction mode includes only an inter prediction mode.

In some implementations, the first prediction mode does not include a geometric partition mode.

In some implementations, determining the second prediction mode according to the sample value of the first reference block includes: determining gradient information corresponding to at least one angle according to the sample value of the first reference block; and determining the second prediction mode according to the gradient information corresponding to the at least one angle.

In some implementations, the gradient information corresponding to the at least one angle is determined based on a decoder-side intra mode derivation (DIMD) mode.

In some implementations, the gradient information corresponding to the at least one angle includes amplitude values corresponding to the at least one angle, and the method further includes: in a case that the amplitude value corresponding to the at least one angle meets a first preset condition, adding the second prediction mode to the candidate set of the intra prediction modes.

In some implementations, the first preset condition is associated with a maximum amplitude value among the amplitude values corresponding to the at least one angle.

In some implementations, the first preset condition includes: the maximum amplitude value is greater than or equal to a target value, the target value being determined based on a sum of remaining amplitude values other than the maximum amplitude value among the amplitude values corresponding to the at least one angle.

In some implementations, determining the second prediction mode according to the sample value of the first reference block includes: in a case that a size of the first reference block meets a second preset condition, determining the second prediction mode based on the sample value of the first reference block.

In some implementations, the first reference block is a prediction block or a reconstructed block.

In some implementations, the target intra prediction mode further includes: a planar mode and a DC mode.

In some implementations, predicting the current block according to the candidate set includes: determining an intra prediction mode of the current block according to the candidate set; and determining a prediction value of the current block according to the intra prediction mode of the current block.

In some implementations, the decoder 1100 further includes units as follows.

A decoding unit, configured to: determine first identification information, the first identification information indicating that a prediction mode of the current block is a target prediction mode, the target prediction mode performing prediction based on the candidate set; and determine first index information, where predicting the current block according to the candidate set includes: determining an intra prediction mode of the current block from the candidate set according to the first index information.

A third determination unit, configured to determine a residual value of the current block; and determine a reconstructed value of the current block according to the prediction value of the current block and the residual value of the current block.

A fourth determination unit, configured to inversely transform the transform coefficient to determine residual information of the current block.

It may be understood that in the embodiment of the disclosure, the “unit” may be a part of a circuit, a part of a processor, a part of a program or software, etc. Certainly, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solution of the embodiment substantially, or parts making contributions to the related art, or all or part of the technical solution may be embodied in a form of software product, and the computer software product is stored in a storage medium, and includes several instructions configured to enable a computer device (which may be a personal computer, a server, a network device, etc.) or a processor to perform all or part of operations of the method described in the embodiment. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer-readable storage medium, the computer-readable storage medium is applied to the decoder 1100. The computer-readable storage medium has stored thereon a computer program, and when the computer program is executed by a processor, the method for decoding in the first embodiment is implemented.

Based on compositions of the above decoder 1100 and the computer-readable storage medium, with reference to FIG. 12, a schematic diagram of specific hardware structures of the decoder 1200 provided in an embodiment of the disclosure is shown. As shown in FIG. 12, the decoder 1200 may include a communication interface 1210, a memory 1220 and a processor 1230, various components are coupled together through a bus system 1240. It may be understood that the bus system 1240 is configured to achieve connection and communication between these components. The bus system 1240 includes a power bus, a control bus and a status signal bus, besides a data bus. However, for the sake of clear explanations, various buses are marked as the bus system 1240 in FIG. 12. Where
the communication interface 1210 is configured to receive and send signals in a process of receiving/sending information from/to other external network elements.

The memory 1220 is configured to store a computer program.

The processor 1230 is configured to: when it executes the computer program, perform operations of:
determining at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode;
determining a second prediction mode according to a sample value of the first reference block, the second prediction mode belonging to the target intra prediction mode;
adding the second prediction mode to a candidate set of intra prediction modes; and
predicting the current block according to the candidate set.

It is understood that the memory 1220 in embodiments of the present disclosure may be volatile memory or non-volatile memory, or may include both volatile and non-volatile memory. The non-volatile memory may be Read-Only Memory (ROM), Programmable ROM (PROM), Erasable PROM (EPROM), Electrically EPROM (EEPROM), or flash memory. The volatile memory may be a Random Access Memory (RAM) which serves as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1220 of the system and method described in the disclosure is intended to include, but is not limited to these memories and any other suitable types of memories.

The processor 1230 may be an integrated circuit chip with a signal processing capability. During implementation, each operation of the above method may be completed by an integrated logical circuit in a form of hardware in the processor 1230 or instructions in a form of software. The above processor 1230 may be a general purpose processor, a Digital Signal Processor (DSP), an Application Specific Integrated Circuit (ASIC), a Field Programmable Gate Array (FPGA) or other programmable logic devices, discrete gates or transistor logic devices, or discrete hardware components. Various methods, operations and logic block diagrams disclosed in the embodiments of the disclosure may be implemented or performed. The general purpose processor may be a microprocessor, or the processor may be any conventional processor, etc. Operations in the methods disclosed in combination with the embodiments of the disclosure may be directly embodied as being performed and completed by a hardware decoding processor, or performed and completed by a combination of hardware in the decoding processor and software modules. The software modules may be located in random memory, flash memory, read-only memory, programmable read-only memory or electrically erasable programmable memory, registers and other storage medium mature in the art. The storage medium is located in the memory 1220, and the processor 1230 reads information in the memory 1220, and completes the operations in the above methods in combination with the hardware thereof.

It may be understood that these embodiments described in the disclosure may be implemented by hardware, software, firmware, middleware, microcode or a combination thereof. As to implementation by hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. As to implementation by software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the processor 1230 is further configured to perform the method for decoding described in the foregoing embodiments when it executes the computer program.

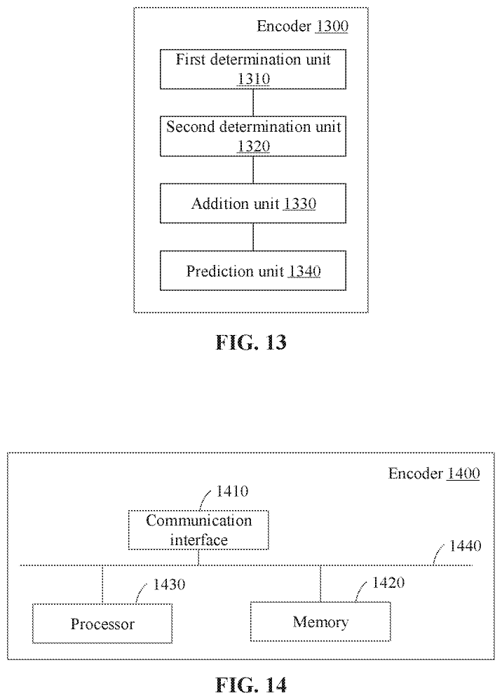

FIG. 13 is a schematic structural diagram of an encoder according to an embodiment of the present disclosure. As shown in FIG. 13, the encoder 1300 includes a first determination unit 1310, a second determination unit 1320, an addition unit 1330, and a prediction unit 1340.

The first determination unit 1310 is configured to determine at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode.

The second determination unit 1320 is configured to determine a second prediction mode according to a sample value of the first reference block, the second prediction mode belonging to the target intra prediction mode.

The addition unit 1330 is configured to add the second prediction mode to a candidate set of intra prediction modes.

The prediction unit 1340 is configured to predict the current block according to the candidate set.

In some implementations, the first prediction mode is a prediction mode based on motion information.

In some implementations, the first prediction mode includes at least one of an intra block coding mode or an inter prediction mode.

In some implementations, the first prediction mode includes only an intra block coding mode; or, the first prediction mode includes only an inter prediction mode.

In some implementations, the first prediction mode does not include a geometric partition mode.

In some implementations, determining the second prediction mode according to the sample value of the first reference block includes: determining gradient information corresponding to at least one angle according to the sample value of the first reference block; and determining the second prediction mode according to the gradient information corresponding to the at least one angle.

In some implementations, the gradient information corresponding to the at least one angle is determined based on a decoder-side intra mode derivation (DIMD) mode.

In some implementations, the gradient information corresponding to the at least one angle includes amplitude values corresponding to the at least one angle, and the method further includes: in a case that the amplitude value corresponding to the at least one angle meets a first preset condition, adding the second prediction mode to the candidate set of the intra prediction modes.

In some implementations, the first preset condition is associated with a maximum amplitude value among the amplitude values corresponding to the at least one angle.

In some implementations, the first preset condition includes: the maximum amplitude value is greater than or equal to a target value, the target value being determined based on a sum of remaining amplitude values other than the maximum amplitude value among the amplitude values corresponding to the at least one angle.

In some implementations, determining the second prediction mode according to the sample value of the first reference block includes: in a case that a size of the first reference block meets a second preset condition, determining the second prediction mode based on the sample value of the first reference block.

In some implementations, the first reference block is a prediction block or a reconstructed block.

In some implementations, the target intra prediction mode further includes: a planar mode and a DC mode.

In some implementations, predicting the current block according to the candidate set includes: determining an intra prediction mode of the current block according to the candidate set; and determining a prediction value of the current block according to the intra prediction mode of the current block.

In some implementations, the encoder 1300 further includes units as follows.

A decoding unit, configured to: signal first identification information in a bitstream, the first identification information indicating that a prediction mode of the current block is a target prediction mode, the target prediction mode performing prediction based on the candidate set; signal first index information to a bitstream, the first index information indicating a position of an intra prediction mode of the current block in the candidate set; and encode the quantization coefficient of the current block.

A third determination unit, configured to determine a residual value of the current block according to a prediction value of the current block.

A fourth determination unit, configured to determine a quantization coefficient of the current block according to the residual value of the current block.

It may be understood that in the embodiment of the disclosure, the “unit” may be a part of a circuit, a part of a processor, a part of a program or software, etc. Certainly, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solution of the embodiment substantially, or parts making contributions to the related art, or all or part of the technical solution may be embodied in a form of software product, and the computer software product is stored in a storage medium, and includes several instructions configured to enable a computer device (which may be a personal computer, a server, a network device, etc.) or a processor to perform all or part of operations of the method described in the embodiment. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer-readable storage medium, the computer-readable storage medium is applied to the encoder 1300. The computer-readable storage medium has stored thereon a computer program, and when the computer program is executed by a processor, the method for decoding in the first embodiment is implemented.

Based on compositions of the above encoder 1300 and the computer-readable storage medium, with reference to FIG. 14, a schematic diagram of specific hardware structures of the encoder 1400 provided in an embodiment of the disclosure is shown. As shown in FIG. 14, the encoder 1400 may include a communication interface 1410, a memory 1420 and a processor 1430, various components are coupled together through a bus system 1440. It may be understood that the bus system 1440 is configured to achieve connection and communication between these components. The bus system 1440 includes a power bus, a control bus and a status signal bus, besides a data bus. However, for the sake of clear explanations, various buses are marked as the bus system 1440 in FIG. 14.

The communication interface 1410 is configured to receive and send signals in a process of receiving/sending information from/to other external network elements.

The memory 1420 is configured to store a computer program.

The processor 1430 is configured to: when it executes the computer program, perform operations of: determining at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode; determining a second prediction mode according to a sample value of the first reference block, the second prediction mode belonging to the target intra prediction mode; adding the second prediction mode to a candidate set of intra prediction modes; and predicting the current block according to the candidate set.

It is understood that the memory 1420 in embodiments of the present disclosure may be volatile memory or non-volatile memory, or may include both volatile and non-volatile memory. The non-volatile memory may be Read-Only Memory (ROM), Programmable ROM (PROM), Erasable PROM (EPROM), Electrically EPROM (EEPROM), or flash memory. The volatile memory may be a Random Access Memory (RAM) which serves as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1420 of the system and method described in the disclosure is intended to include, but is not limited to these memories and any other suitable types of memories.

The processor 1430 may be an integrated circuit chip with a signal processing capability. During implementation, each operation of the above method may be completed by an integrated logical circuit in a form of hardware in the processor 1430 or instructions in a form of software. The above processor 1430 may be a general purpose processor, a Digital Signal Processor (DSP), an Application Specific Integrated Circuit (ASIC), a Field Programmable Gate Array (FPGA) or other programmable logic devices, discrete gates or transistor logic devices, or discrete hardware components. Various methods, operations and logic block diagrams disclosed in the embodiments of the disclosure may be implemented or performed. The general purpose processor may be a microprocessor, or the processor may be any conventional processor, etc. Operations in the methods disclosed in combination with the embodiments of the disclosure may be directly embodied as being performed and completed by a hardware decoding processor, or performed and completed by a combination of hardware in the decoding processor and software modules. The software modules may be located in random memory, flash memory, read-only memory, programmable read-only memory or electrically erasable programmable memory, registers and other storage medium mature in the art. The storage medium is located in the memory 1420, and the processor 1430 reads information in the memory 1420, and completes the operations in the above methods in combination with the hardware thereof.

It may be understood that these embodiments described in the disclosure may be implemented by hardware, software, firmware, middleware, microcode or a combination thereof. As to implementation by hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. As to implementation by software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the processor 1430 is further configured to perform the method for encoding described in the foregoing embodiments when it executes the computer program.

Embodiments of the present disclosure provide a method for encoding, a method for decoding, an encoder, a decoder, and a storage medium to improve prediction performance. Various aspects of the present disclosure are described below.

In a first aspect, there is provided a method for decoding applied to a decoder, the method includes: at least one reference position around a current block is determined, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode; a second prediction mode is determined according to a sample value of the first reference block, the second prediction mode belonging to the target intra prediction mode; the second prediction mode is added to a candidate set of intra prediction modes; and the current block is predicted according to the candidate set.

In a second aspect, there is provided a method for encoding applied to a encoder, the method includes: at least one reference position around a current block is determined, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode; a second prediction mode is determined according to a sample value of the first reference block, the second prediction mode belonging to the target intra prediction mode; the second prediction mode is added to a candidate set of intra prediction modes; and the current block is predicted according to the candidate set.

In a third aspect, there is provided a decoder, which includes: a first determination unit, configured to determine at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode; a second determination unit, configured to determine a second prediction mode according to a sample value of the first reference block, the second prediction mode belonging to the target intra prediction mode; an addition unit, configured to add the second prediction mode to a candidate set of intra prediction modes; and a prediction unit, configured to predict the current block according to the candidate set.

In a fourth aspect, there is provided a decoder, which includes: a memory for storing a computer program; and a processor configured to perform the method of the first aspect when executing the computer program.

In a fifth aspect, there is provided a encoder, which includes: a first determination unit, configured to determine at least one reference position around a current block, the at least one reference position including a first reference position, the first reference position corresponding to a first reference block, the first reference block being predicted based on a first prediction mode, and the first prediction mode not belonging to a target intra prediction mode, the target intra prediction mode at least including an angular prediction mode; a second determination unit, configured to determine a second prediction mode according to a sample value of the first reference block, the second prediction mode belonging to the target intra prediction mode; an addition unit, configured to add the second prediction mode to a candidate set of intra prediction modes; and a prediction unit, configured to predict the current block according to the candidate set.

In a sixth aspect, there is provided a encoder, which includes: a memory for storing a computer program; and a processor configured to perform the method of the second aspect when executing the computer program.

In a seventh aspect, there is provided a computer-readable storage medium, where the computer-readable storage medium stores a computer program that, when executed, implements the method according to the first aspect or the second aspect.

In an eighth aspect, there is provided a computer program product including a computer program that, when executed, implements the method according to the first aspect or the second aspect.

In a ninth aspect, there is provided a non-volatile computer-readable storage medium storing a bitstream, the bitstream being generated by using a method for encoding of an encoder, or the bitstream being decoded by using a method for decoding of a decoder, where the method for decoding is the method of the first aspect, and the method for encoding is the method of the second aspect.

The target intra prediction mode mentioned above can be understood as a conventional intra prediction mode (e.g., an angular prediction mode). In the embodiment of the present disclosure, if the reference block at the reference position around the current block (that is, the first reference block mentioned above) does not correspond to the conventional intra prediction mode, the corresponding conventional intra prediction mode may be determined based on the sample value of the reference block itself. The intra prediction mode determined based on the sample value of the reference block itself is more accurate, which helps to improve the prediction performance of the current block.

It should be noted that in the disclosure, terms “include”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above serial numbers of the embodiments of the disclosure are only for the purpose of descriptions, and do not represent advantages and disadvantages of the embodiments.

The methods disclosed in several method embodiments provided in the disclosure may be arbitrarily combined without conflict, to obtain new method embodiments.

The features disclosed in several product embodiments provided in the disclosure may be arbitrarily combined without conflict, to obtain new product embodiments.

The features disclosed in several method or device embodiments provided in the disclosure may be arbitrarily combined without conflict, to obtain new method or device embodiments.

The above descriptions are only specific implementations of the disclosure, however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure should be subject to the scope of protection of the claims.

1. A method for decoding, applied to a decoder, the method comprising:
determining at least one reference position around a current block, the at least one reference position comprising a first reference position, the first reference position corresponding to a first reference block, the first reference block being predicted based on a first prediction mode, and the first prediction mode not belonging to a target intra prediction mode, the target intra prediction mode at least comprising an angular prediction mode;
determining a second prediction mode according to a sample value of the first reference block, the second prediction mode belonging to the target intra prediction mode;
adding the second prediction mode to a candidate set of intra prediction modes; and
predicting the current block according to the candidate set.

2. The method of claim 1, wherein the first prediction mode is a prediction mode based on motion information.

3. The method of claim 1, wherein the first prediction mode comprises at least one of an intra block coding mode or an inter prediction mode.

4. The method of claim 1, wherein the first prediction mode comprises only an intra block coding mode; or, the first prediction mode comprises only an inter prediction mode.

5. The method of claim 1, wherein the first prediction mode does not comprise a geometric partition mode.

6. The method of claim 1, wherein determining the second prediction mode according to the sample value of the first reference block comprises:
determining gradient information corresponding to at least one angle according to the sample value of the first reference block; and
determining the second prediction mode according to the gradient information corresponding to the at least one angle.

7. The method of claim 6, wherein the gradient information corresponding to the at least one angle is determined based on a decoder-side intra mode derivation (DIMD) mode.

8. The method of claim 6, wherein the gradient information corresponding to the at least one angle comprises amplitude values corresponding to the at least one angle, and the method further comprises:
in a case that the amplitude value corresponding to the at least one angle meets a first preset condition, adding the second prediction mode to the candidate set of the intra prediction modes.

9. The method of claim 8, wherein the first preset condition is associated with a maximum amplitude value among the amplitude values corresponding to the at least one angle.

10. The method of claim 9, wherein the first preset condition comprises: the maximum amplitude value is greater than or equal to a target value, the target value being determined based on a sum of remaining amplitude values other than the maximum amplitude value among the amplitude values corresponding to the at least one angle.

11. The method of claim 1, wherein determining the second prediction mode according to the sample value of the first reference block comprises:
in a case that a size of the first reference block meets a second preset condition, determining the second prediction mode based on the sample value of the first reference block.

12. The method of claim 1, wherein the first reference block is a prediction block or a reconstructed block.

13. The method of claim 1, wherein the target intra prediction mode further comprises: a planar mode and a direct current (DC) mode.

14. The method of claim 1, wherein predicting the current block according to the candidate set comprises:
determining an intra prediction mode of the current block according to the candidate set; and
determining a prediction value of the current block according to the intra prediction mode of the current block.

15. The method of claim 1, further comprising:
parsing a bitstream to determine a residual value of the current block; and
determining a reconstructed value of the current block according to the prediction value of the current block and the residual value of the current block.

16. The method of claim 1, further comprising:
parsing a bitstream to determine first identification information, the first identification information indicating that a prediction mode of the current block is a target prediction mode, the target prediction mode performing prediction based on the candidate set.

17. The method of claim 1, further comprising:
parsing a bitstream to determine first index information;
wherein predicting the current block according to the candidate set comprises:
determining an intra prediction mode of the current block from the candidate set according to the first index information.

18. A method for encoding, applied to an encoder, the method comprising:
determining at least one reference position around a current block, the at least one reference position comprising a first reference position, the first reference position corresponding to a first reference block, the first reference block being predicted based on a first prediction mode, and the first prediction mode not belonging to a target intra prediction mode, the target intra prediction mode at least comprising an angular prediction mode;
determining a second prediction mode according to a sample value of the first reference block, the second prediction mode belonging to the target intra prediction mode;
adding the second prediction mode to a candidate set of intra prediction modes; and
predicting the current block according to the candidate set.

19. A decoder, comprising:
a processor; and
a memory, configured to store a computer program executable by the processor,
wherein the processor is configured to:
determine at least one reference position around a current block, the at least one reference position comprising a first reference position, the first reference position corresponding to a first reference block, the first reference block being predicted based on a first prediction mode, and the first prediction mode not belonging to a target intra prediction mode, the target intra prediction mode at least comprising an angular prediction mode;
determine a second prediction mode according to a sample value of the first reference block, the second prediction mode belonging to the target intra prediction mode;
add the second prediction mode to a candidate set of intra prediction modes; and
predict the current block according to the candidate set.

20. A non-transitory computer-readable storage medium, having computer program and a bitstream stored thereon, wherein the computer program, when executed by a processor, enables the processor to perform the method of claim 18 to generate the bitstream.
